(19) United States
(12) Patent Application Publication
(10) Pub. No.: US 2017/0213383 A1
(43) Pub. Date: Jul. 27, 2017

(54) Displaying Geographic Data on an Image Taken at an Oblique Angle

(71) Applicant: Microsoft Technology Licensing, LLC, Redmond, WA (US)

(72) Inventors: Duncan Murray Lawler, Bothell, WA (US); Philip Max Starhill, Lafayette, CO (US)

(21) Appl. No.: 15/008,330

(22) Filed: Jan. 27, 2016

(51) Int. Cl. G06T 17/05; G06T 1/00; G06T 19/00

(52) U.S. Cl. CPC G06T 17/05; G06T 19/003; G06T 1/0007

(57) ABSTRACT

Systems and methods for displaying geographic data on an image taken at an oblique angle are presented. In order to efficiently allow a user computer to map geographic data on an image taken at an oblique angle, an online source, such as an online image source, provides metadata in conjunction with the image. The metadata includes a projection matrix, approximate elevations information, and a depth bitmap. Upon receipt of the image and metadata, and in displaying the geographic data on the image, an approximate elevation for a given coordinate pair (latitude and longitude) is determined according to the approximate elevations information and a determination as to whether the particular element of geographic data is occluded is determined according to a corresponding depth value in the depth bitmap of the metadata.

### BACKGROUND

Displaying or superimposing geographic data (such as routes, trails, property boundaries, buildings, mapping data, etc.) on an image of an area is relatively simple when the image is displayed at a right angle to the position of the viewer: it's simply a matter of placing the data according to its coordinates. However, displaying or superimposing this same geographic data on an image displayed at an arbitrary, oblique angle to the position of the viewer is significantly more challenging, especially in regard to a real-time request. For example, displaying a road on an aerial image taken from an oblique angle typically computer processing in order to properly place the road within the image and understand where the road is occluded by elements of the image. Given time and processing bandwidth, the geographic data can be accurately displayed on the image. However, displaying that road on an aerial image taken from an oblique angle on a portable computing device with limited storage space and limited network bandwidth and computing capacity in real time pose significant challenges.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

Systems and methods for displaying geographic data on an image taken at an oblique angle are presented. In order to efficiently allow a user computer to map geographic data on an image taken at an oblique angle, an online source, such as an online image source, provides metadata in conjunction with the image. The metadata includes a projection matrix, approximate elevations information, and a depth bitmap. Upon receipt of the image and metadata, and in displaying the geographic data on the image, an approximate elevation for a given coordinate pair (latitude and longitude) is determined according to the approximate elevations information and a determination as to whether the particular element of geographic data is occluded is determined according to a corresponding depth value in the depth bitmap of the metadata.

According to aspects of the disclosed subject matter, a computer-implemented method for responding to an image request is presented. As part of the method, a data store storing a plurality of images is provided. Metadata corresponding to an image of the plurality of image is generated. Generating the metadata comprises determining the geographic boundaries of the image. Additionally, the approximate elevations information for the image are determined and the approximate elevations information for the image are stored in a data store as the metadata corresponding to the image. Additionally, an image request for the image is received from a remotely located computer user and, in response the image and the corresponding metadata are returned.

According to additional aspects of the disclosed subject matter, a computing device for providing an online service in regard to images is provided. The computing device includes, at least, a processor and a memory, wherein the processor executes instructions stored in the memory as part of or in conjunction with additional components to respond to an image query. The additional components include a boundaries generator, a depth bitmap generator, an elevation data generator, a projection matrix generator, and an image service. In operation, the boundaries generator determines the boundaries of an image according to a camera's coordinates, elevation, lens and camera properties, and orientation at the moment that the camera captured the image. The depth bitmap generator generates a depth bitmap comprising a matrix of depth values corresponding to a plurality of geographic coordinates located within the boundaries of an image. Moreover, each depth value is determined according to a distance between a camera lens and a first surface occlusion along a ray from the camera lens to a geographic coordinate at the moment that the image was captured by the camera. The elevation data generator determines approximate elevations data for a given image according to a surface model of the earth's surface corresponding to the image. The projection matrix generator generates a projection matrix according to geographic coordinates, elevation, orientation, and physical properties of a camera and its lens at the moment that the camera captured an image. The image service receives an image request for an image from a remotely located computer user and in response to the image request, returns the image and corresponding metadata. The metadata comprises approximate elevations information generated by the elevation data generator, a depth bitmap generated by the depth bitmap generator, and a projection matrix generated by the projection matrix generator.

According to still further aspects of the disclosed subject matter, a computer-implemented method for displaying geographic data on an image is presented. The method includes obtaining an image and corresponding metadata from an image source. According to aspects of the disclosed subject matter, the image has taken at an oblique angle and the metadata includes, at least, a projection matrix, approximate elevations data, and a depth bitmap. Additionally, geographic data for display on the image is obtained, the geographic data comprising a plurality of elements. For each element of geographic data: an approximate elevation for an element of geographic data is determined according to the approximate elevations data of the metadata; a determination is made as to whether the element of geographic data is occluded in the image according to a corresponding depth value in the depth bitmap of the metadata; and the element of geographic data is displayed in a first manner if the element of geographic data is not occluded in the image, and displayed the element of geographic data in a second manner if the element of geographic data is occluded in the image

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a block diagram illustrating an exemplary network environment suitable for implementing aspects of the disclosed subject matter;

FIG. 2 is a flow diagram illustrating an exemplary routine suitable for generating metadata corresponding to an image;

FIG. 3 is a flow diagram illustrating an exemplary routine for responding to a user request with regard to an image;

FIG. 4 is a flow diagram illustrating an exemplary routine for displaying geographic data on an image taken at an oblique angle;

FIG. 5 is a flow diagram illustrating an exemplary routine for mapping and displaying geographic data onto an image taken from an oblique angle, according to aspects of the disclosed subject matter;

FIG. 6 is a block diagram illustrating an exemplary computer readable medium encoded with instructions to generate metadata in regard to an image, respond to an image request with the image and metadata, and/or request an image from an online image service;

FIG. 7 is a block diagram illustrating an exemplary computing device suitable for generating metadata corresponding to an image and in responding to a user request with regard to an image with the corresponding metadata; and

FIG. 8 is a block diagram illustrating an exemplary user computing device suitable for displaying geographic data on an image taken from an oblique angle.

### DETAILED DESCRIPTION

For purposes of clarity and definition, the term “exemplary,” as used in this document, should be interpreted as serving as an illustration or example of something, and it should not be interpreted as an ideal or a leading illustration of that thing. Stylistically, when a word or term is followed by “(s)”, the meaning should be interpreted as indicating the singular or the plural form of the word or term, depending on whether there is one instance of the term/item or whether there is one or multiple instances of the term/item. For example, the term “user(s)” should be interpreted as one or more users.

For purposes of clarity and definition, the term “digital image” or “image,” as used in this document and as will be readily appreciated by those skilled in the art, should be interpreted as digital photograph, where the binary digits/elements within the containing file represent the image. Typically, though not exclusively, a digital image is the product of digital photography that uses cameras containing arrays of electronic photo-detectors to capture images focused by a lens, as opposed to an exposure on photographic film.

As indicated above, given enough resources and processing bandwidth, a set of geographic data can be accurately displayed on an image taken at an oblique angle. However, displaying that geographic data on a user's computing device in real time poses significant challenge. Indeed, the resource data and computing bandwidth necessary to accurately portray geographic data on an image taken from an oblique angle surpass the capacity of user computers today.

Typically, geographic data, such as routes, paths, roads, boundaries, and the like, are described according to geographic coordinates; more particularly, according to a set of latitude/longitude pairs. While plotting geographic data according to latitude/longitude pairs works well when the image is at a right angle to the viewer, accurately placing the geographic data on an image taken from an oblique angle requires an elevation for each of the latitude/longitude pairs. According to aspects of the disclosed subject matter, by utilizing metadata provided in conjunction with a downloaded image, geographic data can be represented on the digital image on a typical user computer with a high degree of accuracy. The metadata provided in conjunction with the downloaded image include all or some of a projection matrix (based on the coordinates, elevation and the orientation of the camera that took the image), elevation data, and a depth bitmap. Generally speaking the metadata is typically small in comparison to the image, often comprising less than 1% of the downloaded data, and as such is readily downloaded with an image without significant impact on network bandwidth resources.

As indicated above, the metadata provided with, or in addition to, an image includes a projection matrix, elevation data, and a depth bitmap. As those skilled in the art will appreciate, the projection matrix comprises the translation information and/or formulae that enable a location to be plotted on an image from an oblique angle, give the latitude, longitude, and elevation of that point. In order to reduce the amount of elevation data that must be provided for any given image (corresponding to many latitude/longitude pairs), an approximation of the actual elevation is provided. Additionally, as some locations within the image may be obscured due to elevation variations, buildings, etc., the depth bitmap data indicates a distance of a first occlusion from the camera lens along a ray to any given location in the image. By utilizing the metadata provided with, or obtained in conjunction with a given image, geographic data can be accurately placed within an image taken from an oblique angle.

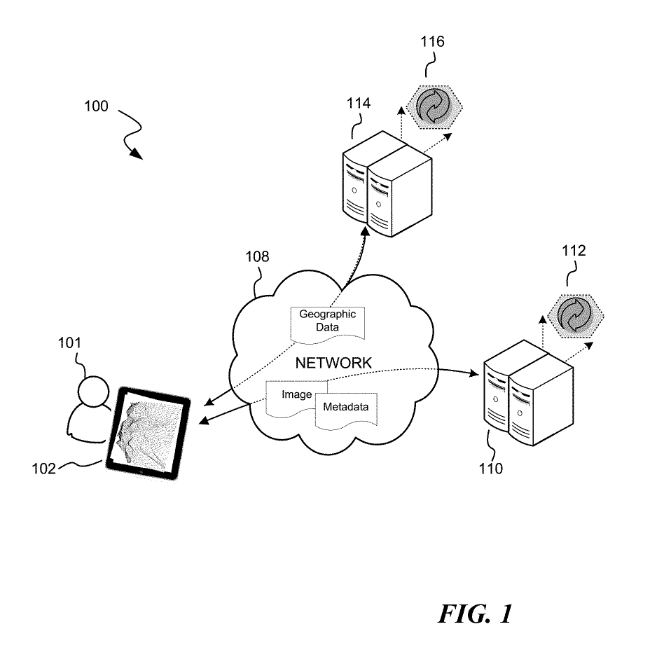

Turning to FIG. 1, FIG. 1 is a block diagram illustrating an exemplary network environment 100 suitable for implementing aspects of the disclosed subject matter. By way of illustration and not limitation, the network environment 100 includes one or more user computer, such as user computer 102, by which a computer user such as computer user 101 can control to view images and geographic data superimposed upon the image. Suitable user computers include, by way of illustration and not limitation, tablet computers such as user computer 102, laptop computers, smart phones, so-called “phablet” computers (hybrid smart phone/tablet computers), personal digital assistants, desktop computers, and the like.

As shown in FIG. 1, a computer user obtains and image 120 from an online service 112 operating on a network computer 110. In addition to the image 120, metadata 122 is also obtained. While shown as being separate from the image 120, the corresponding metadata 122 may be included within the image file.

In addition to obtaining an image, the computer user 101 (via user computer 102) may obtain geographic data 124 from an online service 116 operating on another network computer 114. As indicated above, the geographic data will typically include pairs of latitude/longitude coordinates, but lack elevation data. Based on the metadata 122 obtained from the online service 112, processes on the user computer 102 can accurately render the geographic data on the image taken from an oblique angle, including those instances (typical instances) where the geographic data lacks the corresponding elevation data.

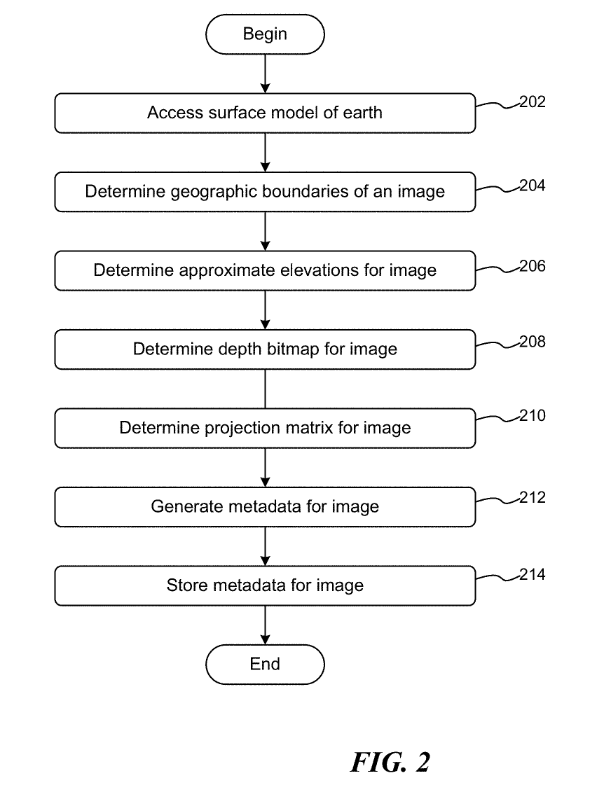

To provide metadata corresponding to an image and in order to avoid significant processing challenges for a user computer such as user computer 102, substantial processing is conducted by the online service 112. FIG. 2 is a flow diagram illustrating an exemplary routine 200 suitable for generating metadata corresponding to an image. Beginning at block 202, the service 112 obtains a surface model corresponding to at least a portion of the earth covering the area of the requested images. As those skilled in the art will appreciate, surface models, while highly accurate in representing a three dimensional representation of the earth's surface (or portion of the earth's surface), are also significantly complex and large such that they are cannot be practically delivered to user computers over a typical network. Advantageously, by utilizing aspects of the disclosed subject matter, the surface model does not need to be downloaded to a user computer in order to render geographic data on an image taken at an oblique angle.

At block 204, an analysis is conducted to determine the geographic coordinates of the boundaries of a particular image that a computer user may view. According to aspects of the disclosed subject matter, the analysis is based on a variety of factors including, by way of illustration and not limitation, the position (geographic coordinates) of the camera at the time that the image was captured, the elevation of the camera, contours and/or elevations of the surface (i.e., elevations regarding the subject matter of the image), the orientation or direction of the camera in taking the image, properties of the camera lens, and the like. Utilizing all or some of this information, the coordinates (latitude/longitude) of the boundaries of the image are determined. Typically though not exclusively, the boundaries are defined according to 4 coordinate pairs, representing the four corners of the image.

According to aspects of the disclosed subject matter, at block 206 approximate elevations information for the image are determined. The approximate elevations information corresponds to a set of information which, given a geographic coordinate with the bounds of the corresponding image of the approximate elevations information, yields an approximate elevation for the given geographic coordinate. In at least one embodiment of the disclosed subject matter, the approximate elevations information is determined according to an average elevation plane or surface based on the elevations and coordinates of the four corners of the image's boundaries. Of course, since the elevations of the image's boundaries (or corners) may not be aligned that a (flat) plane can represent the elevations, a contoured surface/three dimensional plane based on the elevations of the image's boundaries may be generated.

According to various embodiments of the disclosed subject matter, the average elevation plane may alternatively be expressed as a set of triplets (a latitude coordinate, a longitude coordinate, and elevation) for the image, or as a function that models the elevation of the surface. While an average elevation plane is advantageously small and, therefore, does not significantly impact the amount of data that is delivered to the computer user in conjunction with a requested image, other alternatives may be suitably used. For example, a function or formula (or set of functions/formulae), suitable for execution on a user computer, may be derived from the elevations within the image (according to the data in the surface model) such that for any given geographic coordinate pair an approximate elevation for the coordinate pair is determined. While a function or set of functions may be substantially larger than the compact amount of the average elevation plane, a function or set of functions may be sufficiently small that they, too, do not significantly impact the amount of data that is delivered to the computer user in conjunction with a requested image.

As yet a further alternative to an average elevation plane or a set of functions/formulae that can compute an elevation for a given coordinate pair, the approximate elevations information may comprise a low-resolution elevations bitmap. While the surface model of an area is typically highly accurate and requires substantial storage space (as well as processor bandwidth for processing), accordance with aspects of this particular embodiment, a low-resolution elevations bitmap may comprise a given elevation and scale for the bitmap, with the various elevation entries representing a delta from the given elevation. Moreover, the mapping of the bitmap may be such that multiple actual geographic coordinate pairs (latitude/longitude pairs) will map to a single elevation entry within the low-resolution elevations bitmap. By mapping multiple actual geographic coordinates to a single elevation entry, and by representing the elevation as a delta (a change from the given elevation), with the delta being a rough or average estimate of the area that it represents, a low-resolution elevations bitmap may be sufficiently small that it does not significantly impact processing and/or delivery resources. Moreover, while the metadata for an image may include a low-resolution elevations bitmap (or an average elevations plane or a set of functions for determining an approximate elevation), in an alternative embodiment the metadata may simply comprise a reference (such as a hyperlink) to the information for subsequent access and/or retrieval.

At block 208, a depth bitmap for the image is produced. The depth bitmap comprises a matrix of depth values, where each depth value indicates the distance from the camera lens to a first surface occlusion along a ray extending from the camera lens to a coordinate on the earth's surface (geographic coordinate and elevation). While the distance may be determined according to the elevations of the geographic coordinates determined from the surface model (which, generally speaking, reflects the actual elevation at the geographic location), in various embodiments the elevation may be an approximate elevation based on the approximate elevations information corresponding to the image.

The dimension of the matrix of depth values may be determined by design or user configuration according to the resolution that is desired. Moreover, depending on the resolution of the geographic data (degrees, minutes, seconds, tenths, etc.), a mapping between a particular coordinate and a corresponding matrix entry may be necessary. According to aspects of the disclosed subject matter, a legend is included with the depth bitmap such that the identification of a corresponding matrix entry for a given coordinate can be determined.

As indicated above, each depth value in the matrix represents a distance from the camera lens to the first surface occlusion a ray extending from the camera lens to a coordinate on the earth's surface. In order to properly interpret the depth value, the legend of the depth bitmap will also typically include a scale value comprising a conversion of the value to a distance (e.g., a multiplier to convert the value to meters. According to at least one embodiment of the disclosed subject matter, the depth values may be stored as 8-bit values. Alternatively, the depth values may be stored as 16-bit values. Of course, with increased resolution (which comes with increasing the number of bits for storing each depth value) comes increased size in the depth bitmap. Depending on network bandwidth considerations, as well as desired precision, the number of bits used to store depth value may be configured accordingly.

According to aspects of the disclosed subject matter, the matrix size may also be a result of design requirements. As those skilled in the art will appreciate, the higher the resolution (with regard to the number of coordinates mapping to a single depth value, where a higher resolution has fewer coordinates mapping to a single depth value than a lower resolution) of the depth bitmap, the larger the size of the depth bitmap. Accordingly, precision and size may be factors in configuring the size of the depth bitmap. While for precision purposes there may be a 1:1 correspondence between geographic coordinates and entries in the matrix of depth values, for size/bandwidth purposes the depth bitmap may include a many:1 correspondence between geographic coordinates and entries in the matrix of depth values. As with the resolution of the depth values, the legend will also include information that enables mapping of a geographic coordinate to a matrix entry.

At block 210, a projection matrix is determined/generated. The projection matrix is determined according to the geographic coordinates, elevation, orientation, and physical properties of the camera and lens at the moment that the camera captured the image. The projection matrix provides the basis for locating a geographic coordinate within an image taken at an oblique angle. Indeed, the projection matrix comprises translation information and/or formulae that enable a location to be plotted on an image from an oblique angle, give the latitude, longitude, and elevation of that point (geographic location). While based on the set of information, the projection matrix may also include the geographic coordinates, elevation, orientation, and lens properties of the camera lens at the moment that the image was captures.

At block 212, the metadata for the image, comprising the approximate elevations, the depth bitmap, and a projection matrix are organized as the generated metadata. Of course, the metadata need not be generated into the same file for purposes of storage. Indeed, the projection matrix, approximate elevations information, and depth bitmap may be collectively or separately stored in various combinations. After generating the metadata, at block 214, the metadata is saved in a data store for subsequent use in regard to the image. Thereafter, routine 200 terminates.

While routine 200 is described in regard to generating metadata for a single image, it should be appreciated that this routine may be anticipatorily executed in regard to numerous images such that, upon request, the metadata may be delivered in conjunction with an image. Alternatively, metadata for any given image may be generated in an on-demand manner, i.e., generated at the time that it is first requested. Depending on the amount of processing that is needed to generate metadata for any given image, however, it may be more desirable to anticipatorily generate the metadata.

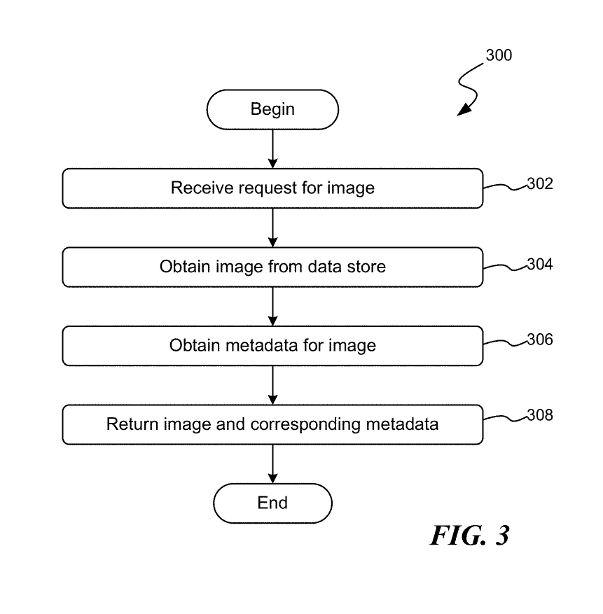

Turning now to FIG. 3, FIG. 3 is a flow diagram illustrating an exemplary routine 300 for responding to a user request with regard to an image, as may be executed by an online image service such as online service 112. Beginning at block 302, a request is received from a computer user, such as computer user 101, for an image. At block 304, the requested image is identified and obtained from a data store. At block 306, metadata (as described above) is obtained. Obtaining the metadata may comprise identifying and retrieving the metadata (projection matrix, depth bitmap, and approximate elevations) from a data store or, alternatively, generating the metadata in an on-demand manner according to the steps described above in regard to routine 200. At block 308, the image and corresponding metadata are returned to the requesting computer user in response to the image request. Thereafter, the routine 300 terminates.

With regard to returning an image to a requesting computer user, while in various embodiments the requested image is returned as a single data file, in alternative embodiments the image may be returned to the requesting computer user as a collection of smaller images that may be composited together on the user computer of the requesting computer user. By downloading images in smaller portions, especially those portions of a requested image that may be currently viewed by the requesting computer user, to the requesting computer user the image may appear to be displayed more quickly with less perceived bandwidth being consumed.

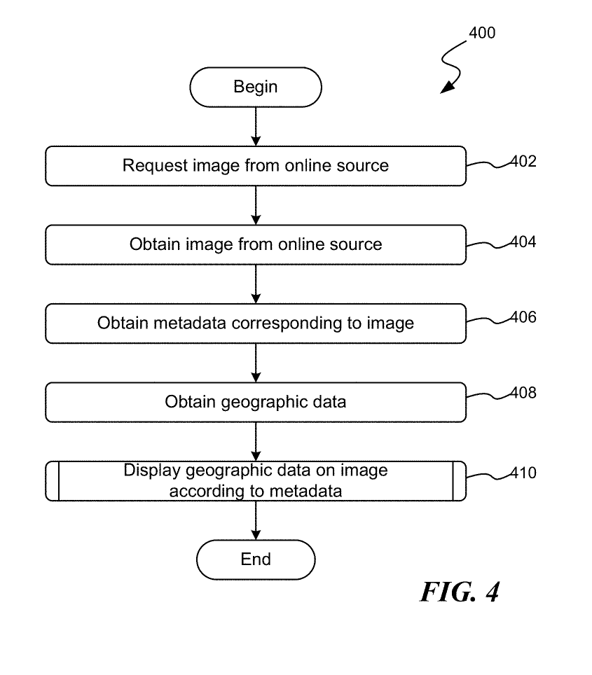

In regard to the operations on a user computer, reference is now made to FIG. 4. FIG. 4 is a flow diagram illustrating an exemplary routine 400 for displaying geographic data on an image taken at an oblique angle. Beginning at block 402, an image is requested from an online image source, such as online source 112 of FIG. 1. At block 404, the image is obtained from the online source. Additionally, as set forth in block 406, metadata corresponding to the obtained image is also obtained. With regard to blocks 404 and 406, while these are shown as separate steps of routine 400, it should be appreciated that obtaining an image may also include obtaining metadata (as descried above, including approximate elevations information, a projection matrix, and a depth bitmap) together.

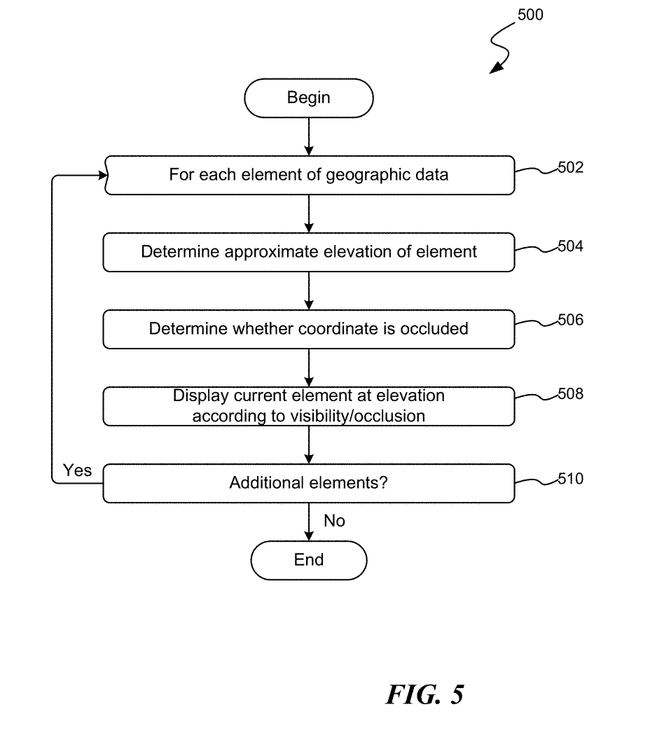

At block 408, geographic data is also obtained, such as obtaining geographic data from an online source 116 of FIG. 1. At block 410, the geographic data is mapped/displayed on the image according to the obtained metadata corresponding to the image. Mapping (and displaying) geographic data on an image taken at an oblique angle according to metadata corresponding to the image is set forth in more detail in regard to FIG. 5.

Turning to FIG. 5, FIG. 5 is a flow diagram illustrating an exemplary routine 500 for mapping and displaying geographic data onto an image taken from an oblique angle, according to aspects of the disclosed subject matter. Beginning at block 502, an iteration loop is begun to iterate through each of the various elements (according to the corresponding coordinates of the element) of the geographic data. At block 504, an approximate elevation of the element is determined. According to various embodiments of the disclosed subject matter, where the approximate elevations information comprises an approximate elevation plane, the determination of the elevation data of the currently iterated element is made by intersecting the coordinates of the current element with the approximate elevation plane to yield the elevation at that intersection which is viewed then as the approximate elevation of the current element. Alternatively, where the approximate elevations information comprises one or more functions, execution of the function according to the coordinates of the current element yields the approximate elevation of the current element.

At block 506, a determination is made as to whether the current element would be occluded from view when placed/mapped on the image. Determination of occlusion is made according to the information in the depth bitmap, part of the metadata obtained in regard to the image. As indicated above, the depth bitmap comprises a matrix of depth values indicating the distance from the camera lens to a first surface occlusion along a ray extending from the camera lens to a coordinate on the earth's surface. Occlusion is determined by whether or not the distance from the camera lens to the current element is the same (or nearly the same, i.e., within some predetermined fault tolerance value) as the corresponding depth value. Indeed, the particular depth value in the matrix of depth values is determined according to the coordinates of the current element, and compared to a determined distance between the point of the camera lens (at the moment of capturing the image) and the coordinates of the current element. If the value of the depth value (scaled according to scaling information associated with the depth bitmap) is less than the actual distance (with or without any fault tolerance), then the current element is occluded from view in the image.

At block 508, the current element is displayed on the image according to the determined approximate elevation of the element and according to the visibility or occlusion of the element on the image. As those skilled in the art will appreciate, displaying/locating the current element at its location on the image is made according to the projection matrix based on the coordinates of the element and the elevation. Of course, while the position of the currently iterated element may be determined, that element may still be occluded. Accordingly, when the currently iterated element is occluded, display of the element may be modified, indicative of an occlusion. Alternatively, the currently iterated element may not be presented/displayed on the image if occluded from view.

At block 510, a determination is made as to whether there are additional elements of the geographic data to display, or whether all elements have been presented, displayed on the image. If there are additional elements to process, the routine 500 returns to block 502 where the next element of the geographic data is selected and processed as described above.

After having processed all of the elements of the geographic data, the routine 500 terminates. Similarly, with reference to routine 400 of FIG. 4, after having mapped/displayed the geographic data on the image, the routine 400 terminates.

Regarding routines 200, 300, 400 and 500 described above, as well as other processes describe herein (such as the process described in regard to network environment 100), while these routines/processes are expressed in regard to discrete steps, these steps should be viewed as being logical in nature and may or may not correspond to any specific actual and/or discrete steps of a given implementation. Also, the order in which these steps are presented in the various routines and processes, unless otherwise indicated, should not be construed as the only order in which the steps may be carried out. Moreover, in some instances, some of these steps may be combined and/or omitted. Those skilled in the art will recognize that the logical presentation of steps is sufficiently instructive to carry out aspects of the claimed subject matter irrespective of any particular development or coding language in which the logical instructions/steps are encoded.

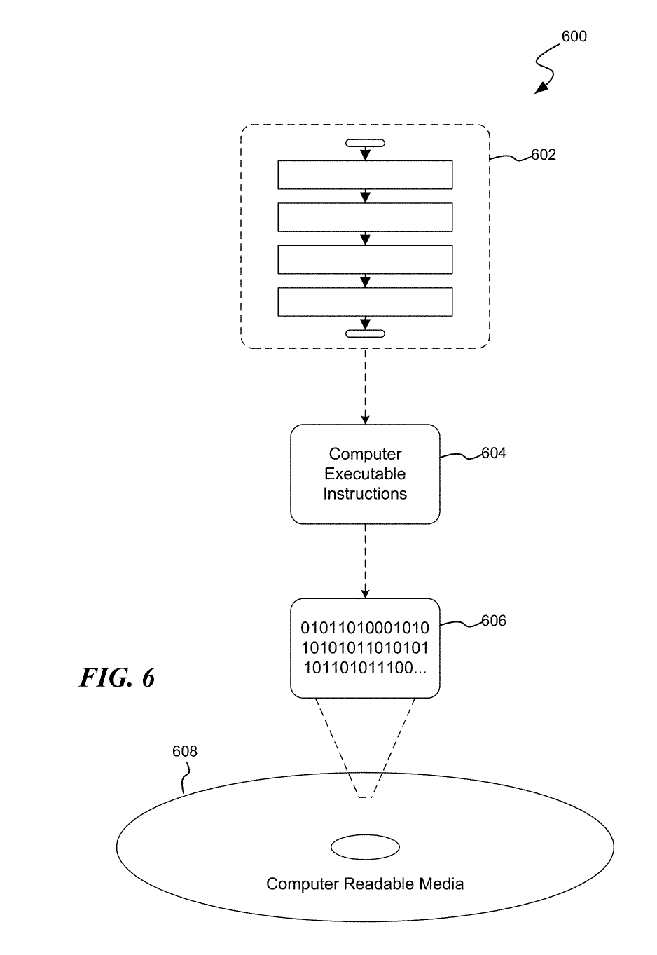

Of course, while these routines include various novel features of the disclosed subject matter, other steps (not listed) may also be carried out in the execution of the subject matter set forth in these routines. Those skilled in the art will appreciate that the logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computing device described in regard FIG. 6 below. Additionally, in various embodiments all or some of the various routines may also be embodied in executable hardware modules including, but not limited to, system on chips (SoC's), codecs, specially designed processors and or logic circuits, and the like on a computer system.

As suggested above, these routines/processes are typically embodied within executable code modules comprising routines, functions, looping structures, selectors and switches such as if-then and if-then-else statements, assignments, arithmetic computations, and the like. However, as suggested above, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied within applications (also referred to as computer programs), apps (small, generally single or narrow purposed applications), and/or methods, these aspects may also be embodied as computer-executable instructions stored by computer-readable media, also referred to as computer-readable storage media, which are articles of manufacture. As those skilled in the art will recognize, computer-readable media can host, store and/or reproduce computer-executable instructions and data for later retrieval and/or execution. When the computer-executable instructions that are hosted or stored on the computer-readable storage devices are executed by a processor of a computing device, the execution thereof causes, configures and/or adapts the executing computing device to carry out various steps, methods and/or functionality, including those steps, methods, and routines described above in regard to the various illustrated routines. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. While computer-readable media may reproduce and/or cause to deliver the computer-executable instructions and data to a computing device for execution by one or more processor via various transmission means and mediums including carrier waves and/or propagated signals, for purposes of this disclosure computer readable media expressly excludes carrier waves and/or propagated signals.

Turning to FIG. 6, FIG. 6 is a block diagram illustrating an exemplary computer readable medium encoded with instructions to generate metadata in regard to an image, respond to an image request with the image and metadata, and/or request an image from an online image service as described above. More particularly, the implementation 600 comprises a computer-readable medium 608 (e.g., a CD-R, DVD-R or a platter of a hard disk drive), on which is encoded computer-readable data 606. This computer-readable data 606 in turn comprises a set of computer instructions 604 configured to operate according to one or more of the principles set forth herein. In one such embodiment 602, the processor-executable instructions 604 may be configured to perform a method, such as at least some of the exemplary methods 200-500, for example. In another such embodiment, the processor-executable instructions 604 may be configured to implement a system, such as at least some of the exemplary systems 700 or 800, as described below. Many such computer-readable media may be devised by those of ordinary skill in the art that are configured to operate in accordance with the techniques presented herein.

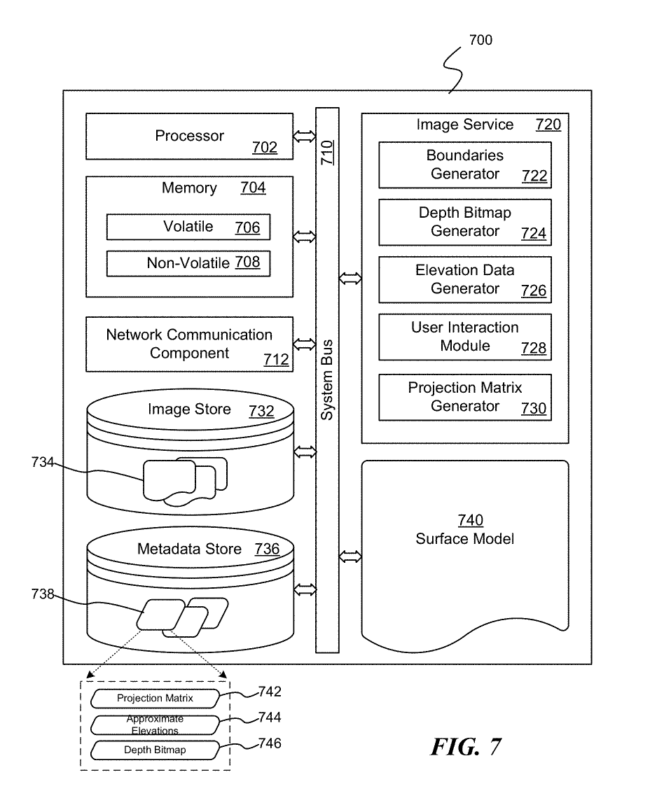

Turning to the various computing systems suitable for implementing aspects of the disclosed subject matter, FIG. 7 is a block diagram illustrating an exemplary computing device 700 suitable for generating metadata corresponding to an image and in responding to a user request with regard to an image with the corresponding metadata. The exemplary computing device 700 includes one or more processors (or processing units), such as processor 702, and a memory 704. The processor 702 and memory 704, as well as other components, are interconnected by way of a system bus 710. The memory 704 typically (but not always) comprises both volatile memory 706 and non-volatile memory 708. Volatile memory 706 retains or stores information so long as the memory is supplied with power. In contrast, non-volatile memory 708 is capable of storing (or persisting) information even when a power supply is not available. Generally speaking, RAM and CPU cache memory are examples of volatile memory 706 whereas ROM, solid-state memory devices, memory storage devices, and/or memory cards are examples of non-volatile memory 708.

As will be appreciated by those skilled in the art, the processor 702 executes instructions retrieved from the memory 704 (and/or from computer-readable media, such as computer-readable media 600 of FIG. 6) in carrying out various functions of a search engine configured to diversity search results as described above. The processor 702 may be comprised of any of a number of available processors such as single-processor, multi-processor, single-core units, and multi-core units.

Further still, the illustrated computing device 700 includes a network communication component 712 for interconnecting this computing device with other devices and/or services over a computer network, including other user devices, such as user computing device 102 of FIG. 1. The network communication component 712, sometimes referred to as a network interface card or NIC, communicates over a network (such as network 108) using one or more communication protocols via a physical/tangible (e.g., wired, optical, etc.) connection, a wireless connection, or both. As will be readily appreciated by those skilled in the art, a network communication component, such as network communication component 712, is typically comprised of hardware and/or firmware components (and may also include or comprise executable software components) that transmit and receive digital and/or analog signals over a transmission medium (i.e., the network.)

The exemplary computing device 700 further includes an image service module 720. The image service module, in execution, carries out the functions of the online image service, such as online service 112, discussed above. As shown in FIG. 7, the image service module 720 includes various sub-components including, by way of illustration and not limitation, a boundaries generator 722, a depth bitmap generator 724, an elevation data generator 726, a projection matrix generator 730, and a user interaction module 728. Of course, it should be appreciated that while these components are illustrated as being sub-components of the image service module 720, this is illustrative of one embodiment. In an alternative embodiment, the image service module 720 does not include sub-components but instead, the computing device 700 includes other components, including some analogous to the boundaries generator 722, the depth bitmap generator 724, the elevation data generator 726, and the user interaction module 728 that cooperatively interact to provide the functionality described below.

In regard to the boundaries generator 722, in execution this component determines the boundaries of an image according to the camera's coordinates, elevation, lens and camera properties, and orientation at the moment that the camera captured the image. Typically, but not exclusively, these boundaries are defined according to a rectangular area (or polygonal area) such that a small set of coordinate pairs (of latitude and longitude), e.g., four corners, can define the boundaries of the image.

The depth bitmap generator 724, in execution, uses a surface model 740 and the projection matrix to iterate through the various coordinates represented within the matrix of depth values and determine a distance between the camera lens (at the time that the image was captured) and a first surface occlusion (i.e., an opaque item on or projecting from the earth's surface) along a ray from the camera lens to a given coordinate. As discussed above, if the distance is less than the distance from the camera lens to the given coordinate at its surface, then there is an occlusion of the image between the coordinate and the camera lens.

The elevation data generator 726, in execution, determines the approximate elevations data the image according to the image and the surface model 740. As indicated above, the approximate elevations data may be represented as an approximate elevation plane or as a function (or set of functions) that can readily determine the approximate elevation of a geographic location (defined by a coordinate pair) through execution of the function(s).

A projection matrix generator 730 is configured to generate/determine a projection matrix according to the geographic coordinates, elevation, orientation, and physical properties of the camera and lens at the moment that the camera captured the image. As mentioned above, the projection matrix provides the basis for locating a geographic coordinate within an image taken at an oblique angle. Indeed, the projection matrix comprises translation information and/or formulae that enable a location to be plotted on an image from an oblique angle, give the latitude, longitude, and elevation of that point (geographic location).

The user interface module 728 is configured to interact with a computer user in regard to an image request by identifying the requested image in an image store 732 as well as corresponding metadata from a metadata store 736, and return both the image and the metadata. While the image store 732 and the metadata store 736 are illustrated in the exemplary computing device 700 as being separate data stores, this is for illustration purposes only and should not be viewed as limiting upon the disclosed subject matter. In various embodiments, the image store 732 and the metadata store 736 may be combined in a single data store and, moreover, both the image and metadata may be stored as a single entity or as separate entities in the data store. As shown in FIG. 7, the image store 732 includes a plurality of images including image 734, and the metadata store 736 may include a corresponding plurality of metadata files, such as metadata 738. Of course, in the event that the image service operates in a just-in-time or on-demand manner in generating metadata for a given image, the metadata stored in the metadata store 736 may not have a 1:1 correspondence, pending generation as needed.

As shown in FIG. 7, metadata such as metadata 738 will typically include at least a projection matrix 742, approximate elevations information 744, and a depth bitmap 746. While the projection matrix 742 is based on information regarding the camera's coordinates, elevation, properties, and orientation, the approximate elevations information 744 and the depth bitmap 746 are generated by the elevation data generator 726 and the depth bitmap generator 724, respectively.

As indicated above and in operation and execution, the image service 720 receives a computer user request for an image (via the user interaction module 728) and identifies the requested image from the image store, such as image 734, determines corresponding metadata, such as metadata 738, and returns both to the requesting computer user in response to the received request. In addition, the image service 720 may be configured to anticipatorily generate metadata for a plurality of images and store the generated metadata in the metadata store in anticipation of a computer user request.

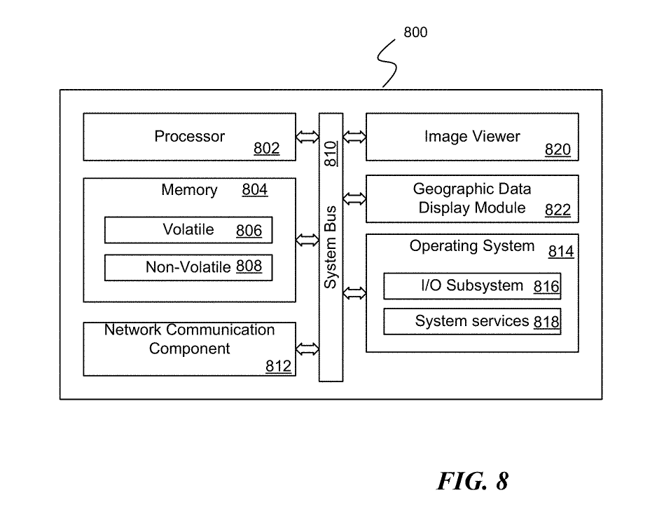

Turning to FIG. 8, FIG. 8 is a block diagram illustrating an exemplary user computing device suitable for displaying geographic data on an image taken from an oblique angle. In similar manner to the exemplary computing device 700 of FIG. 7, the exemplary user computing device 800 includes one or more processors (or processing units), such as processor 802, and a memory 804. The processor 802 and memory 804, as well as other components, are interconnected by way of a system bus 810. The memory 804 typically (but not always) comprises both volatile memory 806 and non-volatile memory 808. Volatile memory 806 retains or stores information so long as the memory is supplied with power. In contrast, non-volatile memory 808 is capable of storing (or persisting) information even when a power supply is not available. Generally speaking, RAM and CPU cache memory are examples of volatile memory 806 whereas ROM, solid-state memory devices, memory storage devices, and/or memory cards are examples of non-volatile memory 808. As will be readily appreciated, exemplary user computing devices include, by way of illustration and not limitation, tablet computers, laptop computers, desktop computers, smart phones, so-called phablets (hybrid smart phone—tablet computing devices), personal digital assistants, and the like.

The processor 802 executes instructions retrieved from the memory 804 (and/or from computer-readable media, such as computer-readable media 600 of FIG. 6) in carrying out various functions of a search engine configured to diversity search results as described above. The processor 802 may be comprised of any of a number of available processors such as single-processor, multi-processor, single-core units, and multi-core units.

Further still, the illustrated user computing device 800 includes a network communication component 812 for interconnecting this computing device with other devices and/or services over a computer network 108, such as network computers 110 and 114 as shown in FIG. 1. The network communication component 812, sometimes referred to as a network interface card or NIC, communicates over a network (such as network 108) using one or more communication protocols via a physical/tangible (e.g., wired, optical, etc.) connection, a wireless connection, or both. As will be readily appreciated by those skilled in the art, a network communication component, such as network communication component 812, is typically comprised of hardware and/or firmware components (and may also include or comprise executable software components) that transmit and receive digital and/or analog signals over a transmission medium (i.e., the network.)

Further still, the exemplary user computing device 800 also includes an operating system 814 that provides functionality and services on the computing device. These services include an I/O subsystem 816 that comprises a set of hardware, software, and/or firmware components that enable or facilitate inter-communication between a user of the computing device 800 and the processing system of the computing device 800. Indeed, via the I/O subsystem 814 a computer operator may provide input via one or more input channels such as, by way of illustration and not limitation, touch screen/haptic input devices, buttons, pointing devices, audio input, optical input, accelerometers, and the like. Output or presentation of information may be made by way of one or more of display screens (that may or may not be touch-sensitive), speakers, haptic feedback, and the like. As will be readily appreciated, the interaction between the computer operator and the computing device 800 is enabled via the I/O subsystem 814 of the user computing device. Additionally, system services 818, provide additional functionality including location services, interfaces with other system components such as the network communication component, and the like.

Also included in the exemplary user computing device 800 is an image view 820. In execution, the image view 820 is configured to display an image and, in conjunction with a geographic data display module 822, display geographic data on an image taken at an oblique angle. As indicated above, displaying geographic data on an image taken at an oblique angle may include not displaying that portion of geographic data that is occluded by one or more obstructions, or displaying that portion of geographic data that is occluded by one or more obstructions in a manner that indicates that the occluded portion of geographic data is occluded from view.

Regarding the various components of the exemplary computing devices 700 and 800, those skilled in the art will appreciate that these components may be implemented as executable software modules stored in the memory of the computing device, as hardware modules and/or components (including SoCs—system on a chip), or a combination of the two. Indeed, components may be implemented according to various executable embodiments including executable software modules that carry out one or more logical elements of the processes described in this document, or as a hardware and/or firmware components that include executable logic to carry out the one or more logical elements of the processes described in this document. Examples of these executable hardware components include, by way of illustration and not limitation, ROM (read-only memory) devices, programmable logic array (PLA) devices, PROM (programmable read-only memory) devices, EPROM (erasable PROM) devices, and the like, each of which may be encoded with instructions and/or logic which, in execution, carry out the functions described herein.

Moreover, in certain embodiments each of the various components of the exemplary computing devices 700 and 800 may be implemented as an independent, cooperative process or device, operating in conjunction with or on one or more computer systems and or computing devices. It should be further appreciated, of course, that the various components described above should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computing device may be combined together or distributed across multiple actual components and/or implemented as cooperative processes on a computer network, such as network 108 of FIG. 1.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for responding to an image request, the method comprising:
providing a data store storing a plurality of images;
generating metadata corresponding to an image of the plurality of image, wherein generating metadata correspond to the image comprises:
determining the geographic boundaries of the image;
determining approximate elevations information for the image; and
storing the approximate elevations information for the image in a data store as the metadata corresponding to the image;
receiving an image request for the image from a remotely located computer user; and
returning the image and the corresponding metadata in response to the image request.

2. The computer-implemented method of claim 1, wherein generating metadata correspond to the image further comprises:
generating a depth bitmap corresponding to the image, wherein the depth bitmap comprises a matrix of depth values for each of a plurality of geographic coordinates within the image, wherein each depth value corresponds to a distance between the camera and a geographic coordinate within the image along a ray between the camera and the geographic coordinate at the time that the image was captured; and
storing the depth bitmap corresponding to the image in the data store with the approximate elevations information as the metadata corresponding to the image.

3. The computer-implemented method of claim 2, wherein generating metadata correspond to the image further comprises:
determining a projection matrix corresponding to the image, wherein the projection matrix is determined according to the geographic coordinates, the elevation, orientation, and camera properties of the camera at the time that the image was captured; and
storing the projection matrix corresponding to the image in the data store with the approximate elevations information and depth bitmap as the metadata corresponding to the image.

4. The computer-implemented method of claim 3, wherein the approximate elevations information is generated according to a plane based on the geographic coordinates and elevations of the image's boundaries.

5. The computer-implemented method of claim 3, wherein the approximate elevations information is generated according to a three dimensional surface based on the geographic coordinates and elevations of the image's boundaries.

6. The computer-implemented method of claim 3, wherein the approximate elevations information is generated according a set of one or more functions that model the elevation of the image.

7. The computer-implemented method of claim 3, wherein the approximate elevations information is generated according to a set of triples of the image, each triplet comprising a latitude coordinate, a longitude coordinate, and an elevation.

8. The computer-implemented method of claim 3, wherein the depth values of the depth bitmap are determined according to the elevations of the geographic coordinates determined from a surface model of the earth's surface corresponding to the area covered by the image.

9. The computer-implemented method of claim 3, wherein the depth values of the depth bitmap are determined according to the approximate elevations information of the corresponding geographic coordinates.

10. The computer-implemented method of claim 3, wherein generating metadata corresponding to the image is conducted in an on-demand manner upon receiving the image request from the remotely located computer user.

11. The computer-implemented method of claim 3, wherein generating metadata corresponding to the image is conducted prior to receiving the image request from the remotely located computer user.

12. The computer-implemented method of claim 3 further comprising and anticipatorily to receiving image requests:
generating metadata corresponding to each of a second plurality of images of the plurality of images; and
storing the metadata corresponding to each of the second plurality of images in a data store.

13. A computing device for providing an online service, the system comprising a processor and a memory, wherein the processor executes instructions stored in the memory as part of or in conjunction with additional components to respond to an image request, the additional components comprising:
a boundaries generator configured to, in execution, determine the boundaries of an image according to a camera's coordinates, elevation, lens and camera properties, and orientation at the moment that the camera captured the image;
a depth bitmap generator configured to, in execution, generate a depth bitmap comprising a matrix of depth values corresponding to a plurality of geographic coordinates located within the boundaries of an image, wherein each depth value is determined according to a distance between a camera lens and a first surface occlusion along a ray from the camera lens to a geographic coordinate at the moment that the image was captured by the camera;
an elevation data generator configured to, in execution, determine approximate elevations data for an image according to a surface model of the earth's surface corresponding to the image;
a projection matrix generator configured to, in execution, generate a projection matrix according to geographic coordinates, elevation, orientation, and physical properties of a camera and its lens at the moment that the camera captured an image; and
an image service, the image service configured to receive an image request for an image from a remotely located computer user via a user interaction module, and in response to the image request:
obtain the requested image from an image store;
generate metadata for the requested image, the metadata comprising approximate elevations information generated by the elevation data generator, a depth bitmap generated by the depth bitmap generator, and a projection matrix generated by the projection matrix generator; and
return the requested image and the generated metadata in response to the image query.

14. The computing device of claim 13, wherein the elevation data generator determines the approximate elevations data for the image according to a plane based on the geographic coordinates and elevations of the image's boundaries.

15. The computing device of claim 13, wherein the elevation data generator determines the approximate elevations data for the image according to a three dimensional surface based on the geographic coordinates and elevations of the image's boundaries.

16. The computing device of claim 13, wherein the elevation data generator determines the approximate elevations data for the image according to a set of one or more functions that model the elevation of the image.

17. The computing device of claim 13, wherein the elevation data generator determines the approximate elevations data for the image according to a set of triples of the image, each triplet comprising a latitude coordinate, a longitude coordinate, and an elevation.

18. The computing device of claim 13, wherein the depth bitmap generator generates the depth bitmap for the image according to the approximate elevations information of the corresponding geographic coordinates.

19. A computer-implemented method for displaying geographic data on an image, the method comprising:
obtaining an image and corresponding metadata from an image source, wherein the image is taken at an oblique angle, and wherein the metadata comprises at least a projection matrix, approximate elevations data, and a depth bitmap;
obtaining geographic data for display on the image comprising a plurality of elements; and
for each element of geographic data:
determine an approximate elevation for an element of geographic data according to the approximate elevations data of the metadata;
determine whether the element of geographic data is occluded in the image according to a corresponding depth value in the depth bitmap of the metadata; and
display the element of geographic data in a first manner if the element of geographic data is not occluded in the image, and display the element of geographic data in a second manner if the element of geographic data is occluded in the image.

20. The computer-implemented method of claim 19, wherein the approximate elevations data is comprises a plane based on the geographic coordinates and elevations of the image's boundaries.
